(19) United States
(12) Patent Application Publication
(10) Pub. No.: US 2010/0257528 A1
(43) Pub. Date: Oct. 7, 2010

(54) ADDING FUNCTIONALITY TO A COMPUTING DEVICE USING THREAD CALL TABLES

(75) Inventor: Dennis May, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 12/063,082

(22) PCT Filed: Aug. 8, 2006
(86) PCT No.: PCT/GB06/02962

§ 371 Date: Jun. 16, 2010

(30) Foreign Application Priority Data
Aug. 10, 2005 (GB) 0516438

(51) Int. Cl. G06F 9/46

(52) U.S. Cl. 718/102

(57) ABSTRACT

A computing device is provided with a plurality of personality layers, each implemented for a respective RTOSs. This enables multiple LRTAs to run on the same device while maintaining real time performance. It can also be used for debugging/diagnostic purposes because it is possible to install a new call table for a given thread which redirects all attempts by that thread to use kernel functionality to a debugger.

This invention relates to a method for adding functionality to a computing device, and in particular to how a plurality of thread call tables in an operating system (OS) kernel can be used to add functionality to a computing device.

It is often advantageous for manufacturers of certain types of devices and others who are seeking to implement existing computing technology on new platforms to try to reuse their existing software materials. This is especially true for consumer devices such as mobile telephones, which tend to have a short market life compared to the time invested in their development; anything that decreases the development cycle and reduces development cost improves manufacturing efficiency.

Communications stacks and protocol implementations are good examples of the software material that manufacturers seek to reuse in modern consumer electronic devices; there is an increasing trend for such devices to converge, and communications and networking capabilities will increasingly be required in many diverse situations and devices. Such software tends to have the following features in common:
they are large complex pieces of software in which a phone manufacturer has made a considerable financial investment
they have significant real time requirements
they have generally been developed to run over some type of real-time operating system (RTOS). These include both proprietary ones and standard commercial systems as Nucleus Plus, VRTX or OSE.

Such software is referred to below as a legacy real time applications (LRTA). There are a number of ways of incorporating an LRTA on to a new platform.

A very straightforward method is by running the LRTA components on their own CPU, separate from the one that handles the functionality on the rest of the device. There are some advantages to this solution: the LRTA need not be modified and the fact that it is completely isolated from rest of the software on the new device reduces the integration burden.

However, there are also disadvantages: the most notable ones are the cost of the extra processor required and the accompanying memory.

Because of the downward cost pressures on modern computing devices, which are mainly responsible for decisions to use the LRTA in the first place, it will usually be the case that the separate processor solution will be rejected as being too expensive. This means that the LRTA must be run on the same CPU as the remainder of the software on the device, and will need to be run under its native operating system (OS). Those skilled in the art will be aware that there are three ways of achieving this:
1. Modify the source code (and possibly design) of the LRTA to run directly under the native OS. Because the LRTA is typically made up of low level components, this will normally be handled by re-engineering it either as a purely kernel-mode device driver, or as a combination of kernel and user mode components.
However, this option is usually commercially unrealistic because of the time it taken to modify the LRTA, the risks involved in doing so, and the problem of creating a second distinct version of the LRTA that then increases the ongoing maintenance burden for the manufacturer concerned.
2. Implement a system in which both the native OS and the LRTA RTOS run concurrently. This can be done either by placing hooks into the native OS kernel at strategic places (interrupt and possibly other exception vectors) to allow the RTOS to run, or by implementing some kind of “hypervisor” that performs context switches between the two operating systems. However, this requires modifications to both operating systems to make calls to the hypervisor to indicate thread switches, priority changes and so on.
This option also has its drawbacks:
   Overall device performance is degraded because of the hooks that are called on every interrupt and every executive call, even if they are not related to the LRTA. The hypervisor system will degrade performance even more due to the presence of more hooks and a whole extra layer of processing on interrupts
   The hooks add additional complication and risk of defects to particularly sensitive areas of code
   Inserting hooks into the native OS kernel to allow the RTOS to run whenever it wants to destroys the OS kernel real time performance, since a low priority thread in the LRTA will take precedence over a high priority thread in the native OS. The hypervisor system would not necessarily suffer from this problem but would be considerably more complicated and incur a larger performance penalty
   The hooks become extremely complicated and hard to manage if more than one RTOS needs to run; this could be necessary, for example, if both a GSM signaling stack and a Bluetooth stack are required and each uses a different RTOS.
3. Implement a personality layer over the native OS kernel, which provides the same application programming interface (API) as the original RTOS, or at least as much of it as is required by the LRTA. The RTOS itself can then be dispensed with and the LRTA can run using the native OS kernel as the underlying real time kernel (assuming of course that is has the capability).

The present invention adopts the personality layer solution outlined above. However, current methods of implementing personality layers require a significant programming overhead. This invention proposes a faster and more elegant scheme for implementing such layers.

According to a first aspect of the present invention there is provided a method of implementing a personality layer for an alien operating system on a computing device running a native operating system which enables software written for the said alien operating system to run on the device, the method comprising;
a. setting up each thread of execution running on the computing device with its own dispatch table used for making system calls to the native operating system; and
b. setting up threads executing applications written for the native operating system with a dispatch table pointing at the system calls for the native operating system; and
c. setting up threads executing applications written for the alien operating system with a variant dispatch table pointing at the system calls corresponding to the personality layer for the alien operating system.

According to a second aspect of the present invention there is provided a computing device arranged to operate in accordance with a method of the first aspect.

According to a third aspect of the present invention there is provided an operating system for causing a computing device to operate in accordance with a method of the first aspect.

An embodiment of the invention will now be described, by way of further example only, with reference to the accompanying drawings, in which:—

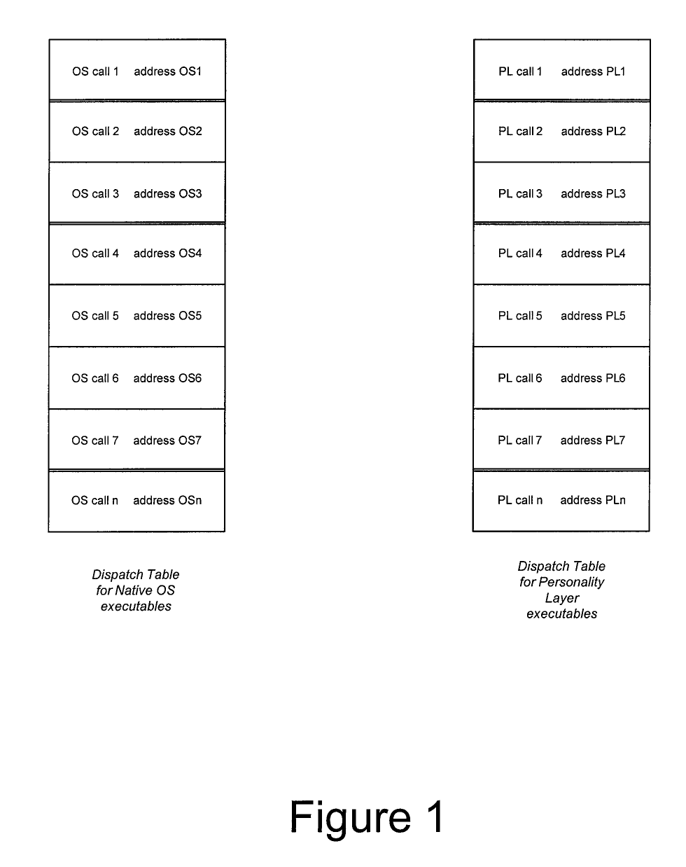

FIG. 1 shows dispatch tables for native OS and personality layer executables in accordance with an aspect of the present invention; and

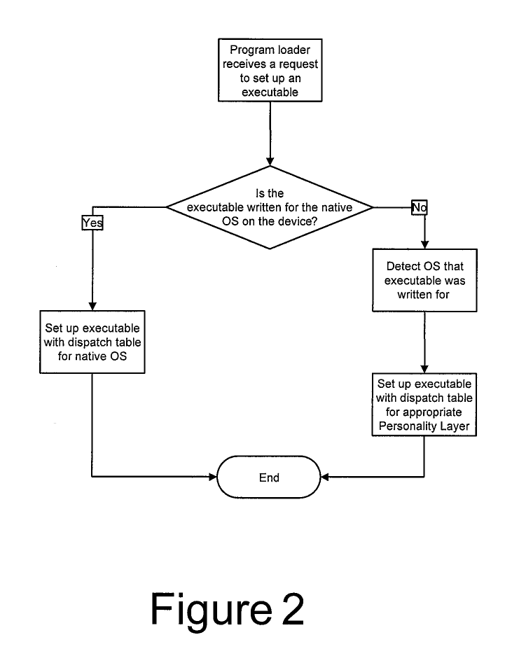

FIG. 2 shows an embodiment of the present invention.

It is usual for system calls in an operating system to be made via some type of jump table. The addresses of the available functions are arranged in a dispatch table with fixed-length entries, and a single entry point for all system calls is provided; this is an address in the kernel. The caller calls the same address for every function, but provides the number of the call they want to make; the number is used to calculate the offset of the address of the actual function required in the dispatch table, and control is passed to that function.

Existing operating systems set up threads of execution in such a way that all threads are provided with the same entry point for making system calls, which all use the same dispatch table.

In this invention, the entry point to the kernel remains the same for all threads and all system calls. However, each thread has its own dispatch table for system calls.

All native OS threads are set up with the same dispatch table, which enables them to access the system calls usually made available under the OS. A dispatch table for native OS executables is shown on the left hand side of FIG. 1.

However, alien threads which need to run in a personality layer provided inside the OS are set up with different dispatch tables. Thus, when alien threads make a system call, they are vectored off by this different table, which provides them with the functionality they would expect from the alien OS for which they were originally written. A dispatch table for personality layer executables is shown on the right hand side of FIG. 1.

FIG. 2 shows a flow chart of a procedure for operating a computing device according to the present invention. Initially, a program loader receives a request to set up an executable on a device. The device firstly determines whether the executable has been written for the OS that is native on the device. If ‘yes’, the executable is set up with a dispatch table for the native OS to provide the desired functionality for the executable to run.

However, if it is determined that the executable is not written for the OS native to the device, the device next determines what OS the executable was written for and the executable is set up with a dispatch table for a personality layer which is appropriate for the OS that the executable was written for so that it is provided with the functionality for it to be able to run on the device.

This invention enables, therefore, multiple personality layers to be implemented for multiple RTOSs thus enabling multiple LRTAs to run on the same device while maintaining real time performance. It can also be used for debugging/diagnostic purposes because it is possible to install a new call table for a given thread which redirects all attempts by that thread to use kernel functionality to a debugger.

Although the present invention has been described with reference to particular embodiments, it will be appreciated that modifications may be effected whilst remaining within the scope of the present invention as defined by the appended claims.

1. A method of implementing a personality layer for an alien operating system on a computing device running a native operating system which enables software written for the said alien operating system to run on the device, the method comprising;
a. setting up each thread of execution running on the computing device with its own dispatch table used for making system calls to the native operating system; and
b. setting up threads executing applications written for the native operating system with a dispatch table pointing at the system calls for the native operating system; and
c. setting up threads executing applications written for the alien operating system with a variant dispatch table pointing at the system calls corresponding to the personality layer for the alien operating system.

2. A computing device arranged to operate in accordance with a method as claimed in claim 1.

3. An operating system for causing a computing device to operate in accordance with a method as claimed in claim 1.
